(19) United States
(12) Patent Application Publication
(10) Pub. No.: US 2010/0249278 A1
(43) Pub. Date: Sep. 30, 2010

(54) RUBBER COMPOSITION FOR INNER LINER AND TIRE HAVING INNER LINER COMPRISING THEREOF

(76) Inventor: Tatsuya Miyazaki, Hyogo (JP)

Correspondence Address: BIRCH STEWART KOLASCH & BIRCH, PO BOX 747, FALLS CHURCH, VA, 22040-0747, US

(21) Appl. No.: 12/682,181

(22) PCT Filed: Sep. 9, 2008
(86) PCT No.: PCT/JP2008/066220

§ 371 Date: Apr. 8, 2010

(30) Foreign Application Priority Data
Dec. 10, 2007 (JP) 2007-317997

(51) Int. Cl. C08K 3/36; C08L 7/00; C08K 3/04

(52) U.S. Cl. 523/438; 524/588

(57) ABSTRACT

The present invention provides a rubber composition for an inner liner including 21 to 50 parts by weight of (B) carbon black and/or silica and 0.25 to 6 parts by weight of (C) an alkylphenol-sulfur chloride condensate indicated by the formula (C1):

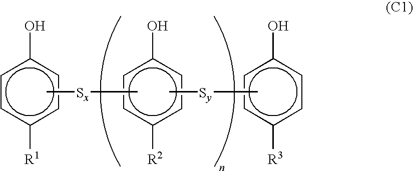

(Wherein R¹ to R³ are same or different and either is an alkyl group having 5 to 12 carbons; x and y are same or different and either is an integer of 2 to 4; and n is an integer of 0 to 10.), wherein whole sulfur content is 0.3 to 1.5 parts by weight, based on 100 parts by weight of (A) a rubber component including 60 to 100% by weight of a butyl rubber for the purpose of keeping air permeation resistance and improving low heat build-up property and durability.

### TECHNICAL FIELD

The present invention relates to a rubber composition for an inner liner and a tire having an inner liner comprising thereof.

### BACKGROUND ART

The low heat build-up and light weighting of a tire has been recently designed from social strong request for low fuel cost. And, among tire members, the light weighting of an inner liner provided in the inside of a tire and having functions of reducing air leak quantity (air permeation quantity) from the inside of a pneumatic tire to the outside and improving air retention property has been also carried out.

At present, as a rubber composition for an inner liner, the improvement of the air retention property of a tire is carried out by compounding a butyl rubber. However, the butyl rubber is superior in a lowering effect of air permeation quantity, but since sulfur is hardly dissolved, there have been problems that crosslinking density is low and adequate strength is not obtained. In particular, when the butyl rubber and a natural rubber are used in combination as rubber components, it has been difficult that crosslinking density is heightened and heat build-up property is reduced.

Japanese Unexamined Patent Publication No. 2006-328193 describes that crack growth resistance is improved by compounding a butadiene rubber as a rubber component in a rubber composition for an inner liner including mica, in addition to a butyl rubber, a natural rubber or an isoprene rubber. However, there has been a problem that when the compounding ratio of a butadiene rubber is increased, the air permeation quantity is increased.

Thus, it has been difficult that all properties such as air permeation resistance, low heat build-up property and strength at break are improved in the rubber composition for an inner liner.

### DISCLOSURE OF INVENTION

It is the purpose of the present invention to provide a rubber composition for an inner liner keeping air permeation resistance and superior in low heat build-up property and durability.

The present invention relates to a rubber composition for an inner liner including 21 to 50 parts by weight of (B) carbon black and/or silica and 0.25 to 6 parts by weight of (C) an alkylphenol-sulfur chloride condensate indicated by the formula (C1):

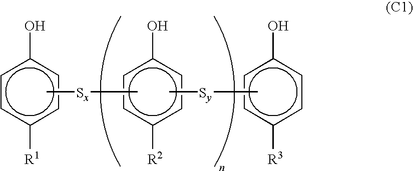

(Wherein R¹ to R³ are same or different and either is an alkyl group having 5 to 12 carbons; x and y are same or different and either is an integer of 2 to 4; and n is an integer of 0 to 10.), wherein whole sulfur content is 0.3 to 1.5 parts by weight, based on 100 parts by weight of (A) a rubber component including 60 to 100% by weight of a butyl rubber.

The rubber composition for an inner liner preferably includes 60 to 80% by weight of the butyl rubber as the rubber component (A).

Further, the present invention relates to a tire having an inner liner comprising the rubber composition for an inner liner.

### BEST MODE FOR CARRYING OUT THE INVENTION

The rubber composition for an inner liner of the present invention includes a rubber component (A) including a butyl rubber, carbon black and/or silica (B) and an alkylphenol-sulfur chloride condensate (C).

The rubber component (A) includes a butyl rubber. The butyl rubber includes, for example, a butyl rubber (IIR), a brominated butyl rubber (Br-IIR) and a chlorinated butyl rubber (Cl-IIR). Among them, a brominated butyl rubber or a chlorinated butyl rubber is preferable from a viewpoint that since bad adhesion is provoked when vulcanization speed with adjacent members such as a chafer and a clinch is different, vulcanization speed is about equal level as the adjacent members, bad adhesion with the adjacent members is suppressed and suitable hardness is obtained.

The content of the butyl rubber in the rubber component (A) is at least 60% by weight and preferably at least 65% by weight because air permeation resistance is superior. Further, the content of the butyl rubber in the rubber component (A) may be 100% by weight because air permeation resistance is superior, may be at most 90% by weight and preferably at most 80% by weight because processability can be improved.

Further, a natural rubber (NR), an isoprene rubber (IR), an epoxidized natural rubber (ENR) and a butadiene rubber (BR) may be included in the rubber component (A) in addition to the butyl rubber.

The NR is not specifically limited and those such as RSS#3 and TSR20 that are generally used in the tire industry are mentioned. Further, as the IR, those that are generally used in the tire industry are also similarly mentioned. Among them, TSR20 is preferable because fracture property can be secured at low cost.

When NR and/or IR are included in the rubber component (A), the content of NR and/or IR in the rubber component (A) is preferably at most 40% by weight and more preferably at most 35% by weight because processability can be improved. Further, NR and/or IR may be not included in the rubber component (A) and at least 10% by weight may be included because strength at break and processability are superior.

A commercially ENR may be used as the ENR and NR may be epoxidized to be used. A method of epoxidizing NR is not specifically limited and methods such as a chlorohydrin method, a direct oxidation method, a hydrogen peroxide method, an alkylhydroperoxide method and a peracid method are mentioned. For example, as the peracid method, methods such as a method of reacting organic acids such as peracetic acid and performic acid are mentioned.

The epoxidization ratio of the ENR is preferably at least 15% by mol and more preferably at least 20% by mol because air permeation resistance is superior. Further, the epoxidization ratio of the ENR is preferably at most 55% by mol and more preferably at most 50% by mol because low heat build-up property is superior.

The epoxidized natural rubber includes specifically “ENR25” in which an epoxidization ratio is 25%, manufactured by Kumplan Gathrie Berhad, and “ENR50” in which an epoxidization ratio is 50%, manufactured by Kumplan Gathrie Berhad.

When the ENR is compounded in the rubber component (A), it is preferably at most 40% by weight and more preferably at most 35% by weight because air permeation resistance is superior. Further, the ENR may not be included in the rubber component (A) and it may be included by at least 10% by weight because it is superior in strength at break.

As the BR, those such as, for example, BR150B and BR130B (manufactured by Ube Industries Ltd.) that are generally used in the tire industry are mentioned. Further, additionally, a butadiene rubber including 1,2-syndiotactic polybutadiene crystals (SPB-including BR) may be used.

When the BR is compounded in the rubber component (A), the content of the BR in the rubber component (A) is preferably at most 40% by weight and more preferably at most 35% by weight because air permeation resistance is superior. Further, the BR may not be in included in the rubber component (A) and at least 10% by weight may be included because crack growth resistance is superior.

The nitrogen adsorption specific surface area (N₂SA) of carbon black that is used as carbon black and/or silica (B) is preferably at least 20 m²/g and more preferably at least 25 m²/g because adequate reinforcing property is obtained and crack growth resistance is superior. Further, the N₂SA of carbon black is preferably at most 70 m²/g, more preferably at most 60 m²/g and further preferably at most 40 m²/g because the hardness of a rubber is suppressed and low heat build-up property is superior.

As silica used as carbon black and/or silica (B), those prepared by a wet method and those prepared by a dry method are mentioned, but they are not specifically limited.

The nitrogen adsorption specific surface area (N₂SA) of silica is preferably at least 80 m²/g and more preferably at least 100 m²/g because reinforcing property and strength at break are superior. Further, the N₂SA of silica is preferably at most 200 m²/g, more preferably at most 180 m²/g and further preferably at most 150 m²/g because the hardness of a rubber is suppressed and low heat build-up property is superior.

The content of carbon black and/or silica (B) is at least 21 parts by weight, preferably at least 25 parts by weight and more preferably at least 30 parts by weight based on 100 parts by weight of the rubber component (A) because strength at break is superior. Further, the content of carbon black and/or silica (B) is at most 50 parts by weight and preferably at most 45 parts by weight based on 100 parts by weight of the rubber component (A) because low heat build-up property is superior.

Further, when the rubber composition of the present invention includes silica as the carbon black and/or silica (B), it can further include a silane coupling agent. The silane coupling agent is not specifically limited and those that are conventionally used in combination with silica can be used. The example of the silane coupling agent includes sulfides series such as bis(3-triethoxysilylpropyl)tetrasulfide, bis(2-triethoxysilylethyl)tetrasulfide, bis(4-triethoxysilylbutyl)tetrasulfide, bis(3-trimethoxysilylpropyl)tetrasulfide, bis(2-trimethoxysilylethyl)tetrasulfide, bis(4-trimethoxysilylbutyl)tetrasulfide, bis(3-triethoxysilylpropyl)trisulfide, bis(2-triethoxysilylethyl)trisulfide, bis(4-triethoxysilylbutyl)trisulfide, bis(3-trimethoxysilylpropyl)trisulfide, bis(2-trimethoxysilylethyl)trisulfide, bis(4-trimethoxysilylbutyl)trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N,N-dimethylthiocarbamoyltetrasulfide, 3-triethoxysilylpropyl-N,N-dimethylthiocarbamoyltetrasulfide, 2-triethoxysilylethyl-N,N-dimethylthiocarbamoyltetrasulfide, 2-trimethoxysilylethyl-N,N-dimethylthiocarbamoyltetrasulfide, 3-trimethoxysilylpropylbenzothiazolyltetrasulfide, 3-triethoxysilylpropylbenzothiazolyltetrasulfide, 3-triethoxysilylpropyl methacrylate monosulfide and 3-trimethoxysilylpropyl methacrylate monosulfide; mercapto series such as 3-mercaptopropyltrimethoxysilane, 3-mercaptopropyltriethoxysilane, 2-mercaptoethyltrimethoxysilane and 2-mercaptoethyltriethoxysilane; vinyl series such as vinyl triethoxysilane and vinyl trimethoxysilane; amino series such as 3-aminopropyltriethoxysilane, 3-aminopropyltrimethoxysilane, 3-(2-aminoethyl)aminopropyltriethoxysilane and 3-(2-aminoethyl)aminopropyltrimethoxysilane; glycidoxy series such as γ-glycidoxypropyltriethoxysilane, γ-glycidoxypropyltrimethoxysilane, γ-glycidoxypropylmethyldiethoxysilane and γ-glycidoxypropylmethyldimethoxysilane; nitro series such as 3-nitropropyltrimethoxysilane and 3-nitropropyltriethoxysilane; chloro series such as 3-chloropropyltrimethoxysilane, 3-chloropropyltriethoxysilane, 2-chloroethyltrimethoxysilane and 2-chloroethyltriethoxysilane.

The content of the silane coupling agent is preferably at least 4 parts by weight and more preferably at least 6 parts by weight based on 100 parts by weight of silica because silica can be dispersed, strength at break can be highly kept and low heat build-up property is superior. Further, the content of the silane coupling agent is preferably at most 10 parts by weight and more preferably at most 9 parts by weight because the excessive rising of crosslinking density can be suppressed and scorch property is superior.

The alkylphenol-sulfur chloride condensate (C) is a compound represented by the formula (C1):

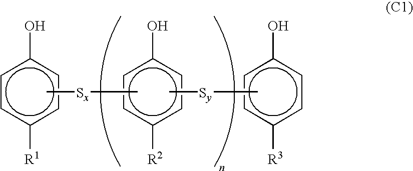

(Wherein R¹ to R³ are same or different and either is an alkyl group having 5 to 12 carbons; x and y are same or different and either is an integer of 2 to 4; and n is an integer of 0 to 10.).

The alkylphenol-sulfur chloride condensate (C) represented by the formula (C1) has good solubility and dispersibility for the butyl rubber and NR and IR capable of being used in combination with the butyl rubber in the rubber component (A) and has an effect of uniformly preparing crosslinking.

n is an integer of 0 to 10 and preferably an integer of 1 to 9 because the dispersibility of the alkylphenol-sulfur chloride condensate (C) in the rubber component (A) is good.

x and y are same or different, and either is an integer of 2 to 4 and both are preferably 2 because high hardness can be efficiently expressed (the suppression of reversion).

R¹ to R³ are same or different and either is an alkyl group having 5 to 12 carbons and preferably an alkyl group having 6 to 9 carbons because the dispersibility of the alkylphenol-sulfur chloride condensate (C) in the rubber composition (A) is good.

The alkylphenol-sulfur chloride condensate (C) can be prepared by known methods and its method is not specifically limited, but for example, a method of reacting alkylphenol with sulfur chloride, for example, at a molar ratio of 1:0.9 to 1.25 is mentioned.

As the specific example of the alkylphenol-sulfur chloride condensate (C), there is mentioned TACKROL V200 available from Taoka Chemical Co., Ltd. in which n is 0 to 10, x and y are 2, R is C₈H₁₇ (octyl group) and the content of sulfur is 24% by weight:

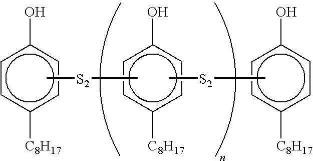

(Wherein n is an integer of 0 to 10.). The sulfur content of the alkylphenol-sulfur chloride condensate (C) means a proportion that is optically quantitatively determined from the quantity of gas generation after heating it at 800 to 1000° C. in a combustion furnace and converting it to SO₂ gas or SO₃ gas.

The content of the alkylphenol-sulfur chloride condensate (C) is at least 0.25 parts by weight and preferably at least 1.0 parts by weight based on 100 parts by weight of the rubber component (A) because the generation of scorch (early vulcanization) can be suppressed, tan δ can be reduced and heat build-up property can be suppressed. Further, the content of the alkylphenol-sulfur chloride condensate (C) is at most 6 parts by weight and preferably at most 5 parts by weight based on 100 parts by weight of the rubber component (A) because the generation of rubber scorch can be suppressed.

In the present invention, whole sulfur content means the total amount of sulfur content included in the alkylphenol-sulfur chloride condensate (C) and sulfur content included in powder sulfur directly compounded and sulfur processed with oil if necessary. Further, since sulfur included in di-2-benzothiazolyldisulfide (for example, NOCCELER DM manufactured by OUCHISHINKO CHEMICAL INDUSTRIAL CO., LTD.) and N-tert-butyl-2-benzothiazylsulfenamide (for example, NOCCELER NS manufactured by OUCHISHINKO CHEMICAL INDUSTRIAL CO., LTD.) that can be compounded as a vulcanization accelerator is not discharged in a rubber, it is not included in the whole sulfur content.

The whole sulfur content is at least 0.3 parts by weight and preferably at least 0.4 parts by weight based on 100 parts by weight of the rubber component (A) because the improvement of hardness and strength at break are superior. Further, the whole sulfur content is at most 1.5 parts by weight based and preferably at most 1.4 parts by weight because the retention property of strength at break after running (strength at break after thermal aging) is superior.

When disodium hexamethylene bisthiosulfate dihydrate (for example, Duralink HTS available from Flexsys Chemicals Sdn. Bhd.) compounded as a vulcanization accelerator and a silane coupling agent are compounded, the whole sulfur content included in the rubber composition of the present invention includes sulfur content derived from these, in addition to sulfur content derived from the alkylphenol-sulfur chloride condensate (C) and sulfur content included in powder sulfur.

The content of sulfur is preferably at least 0.1 parts by weight and more preferably at least 0.15 parts by weight based on 100 parts by weight of the rubber component (A) because suitable hardness can be obtained and strength at break is superior. Further, the content of sulfur is at most 0.49 parts by weight and preferably at most 0.45 parts by weight based on 100 parts by weight of the rubber component (A) because the lowering of elongation at break (EB) because of excessive whole sulfur content is suppressed, bloom caused by sulfur is suppressed and crack growth resistance is superior. Here, when insoluble sulfur is compounded as sulfur, the content of sulfur means the content of pure sulfur excluding oil content.

Further, the rubber composition for an inner liner of the present invention may include mica, calcium carbonate and talc because polymer components are relatively reduced to be able to reinforce a rubber and cost can be reduced. But the rubber composition for an inner liner of the present invention does not preferably include preferably mica because when mica with an average particle diameter of several tens micron is compounded, it becomes the nuclei of crack growth.

Mineral oil can be further compounded in the rubber composition for an inner liner of the present invention because it is superior in compatibility with a halogenated butyl rubber. The specific example of the mineral oil includes DIANA PROCESS PA32 available from Idemitsu Kosan Co., Ltd., Mineral Oil available from Japan Energy Corporation and Super Oil M32 available from NIPPON OIL CORPORATION.

The content of the mineral oil is preferably at least 4 parts by weight and more preferably at least 5 parts by weight based on 100 parts by weight of the rubber component (A) because sheet processability and adhesive property are superior. Further, the content of the mineral oil is preferably at most 20 parts by weight and more preferably at most 16 parts by weight based on 100 parts by weight of the rubber component (A) because air permeation resistance is superior and the transfer of oil to an adjacent member is prevented.

In the rubber composition for an inner liner of the present invention, compounding agents usually used in the tire industry such as, for example, a vulcanization accelerator, zinc oxide, an antioxidant and stearic acid can be suitably compounded, in addition to the rubber component (A), carbon black and/or silica (B), the alkylphenol-sulfur chloride condensate (C), sulfur, the silane coupling agent and mineral oil.

The rubber composition of the present invention can be prepared by a usual method. Namely, the rubber composition of the present invention can be prepared by kneading the rubber component (A), carbon black and/or silica (B) and other compounding agents if necessary, with a Banbury mixer, a kneader and an open roll, then compounding the alkylphenol-sulfur chloride condensate (C), a vulcanizing agent such as sulfur, a vulcanization accelerator and zinc oxide to carry out final kneading and vulcanizing the mixture.

The tire of the present invention is produced by a usual process using the rubber composition for an inner liner of the present invention as an inner liner. Namely, the rubber composition for an inner liner of the present invention is extruded and processed in match with the shape of the inner liner at an unvulcanized stage and laminated with other tire members on a tire molding machine to form unvulcanized tires. The tires of the present invention can be produced by heating and pressuring the unvulcanized tires in a vulcanization machine.

### EXAMPLES

The present invention will be specifically described based on Examples, but the present invention is not limited only to these.

Various chemicals used in Examples and Comparative Examples will be described in summary.

Butyl rubber: EXXON CHLOROBUTYL 1068 (chlorobutyl rubber) manufactured by Exxon Mobile Inc.
Natural rubber (NR): TSR 20.
Epoxidized natural rubber (ENR): ENR25 (epoxidization ratio: 25% by mol) manufactured by Kumplan Gathrie Berhad.
Carbon black: SEAST V (N660, N₂SA: 27 m²/g) available from Tokai Carbon Co., Ltd.
Silica: Z115 GR (N₂SA: 112 m²/g) available from RHODIA S.A.
Stearic acid: TSUBAKI manufactured by Nihon Oil & Fats Co., Ltd.
Mineral oil: DIANAPROCESS PA32 available from Idemitsu Kosan Co., Ltd.
Silane coupling agent 2: Si69 (bis(3-triethoxysilylpropyl)tetrasulfide, sulfur content: 23% by weight) available from Degussa Huls Co.
Zinc oxide: GINREI R manufactured by Toho Zinc Co., Ltd.
Powder sulfur: 5% Oil-treated Powder Sulfur available from Tsurumui Chemical Industry Co., Ltd.
Vulcanization accelerator DM: NOCCELER DM (Di-2-benzothiazolyldisulfide) manufactured by OUCHISHINKO CHEMICAL INDUSTRIAL CO., LTD.
TACKROL V200: TACKROL V200 (Alkylphenol-sulfur chloride condensate, n: 0 to 10, x and y are 2, R: an alkyl group of C81117, and content of sulfur: 24% by weight) available from Taoka Chemical Co., Ltd.

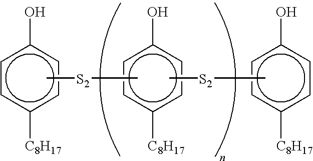

HTS: Duralink HTS (Disodium hexamethylene bisthiosulfate dihydrate and sulfur content: 56% by weight) available from Flexsys Chemicals Sdn. Bhd.

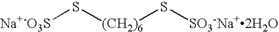

### Examples 1 to 13 and Comparative Examples 1 to 5

Various chemicals excluding the alkylphenol-sulfur chloride condensate, sulfur, a vulcanization accelerator and zinc oxide were added and kneaded under the condition of a maximum temperature of 150° C. for 4 min with a Banbury mixer according to the compounding prescription shown in Table 1, to obtain kneaded articles. Then, the alkylphenol-sulfur chloride condensate, sulfur, a vulcanization accelerator and zinc oxide were added to the kneaded products obtained, and the mixtures were kneaded with a biaxial open roll under the condition of a maximum temperature of 95° C. for 4 min, to obtain unvulcanized rubber compositions. The unvulcanized rubber compositions obtained were rolled in sheet shape with a mold and vulcanized by press under the condition of 170° C. for 12 minutes, to prepare the vulcanized rubber sheets of Examples 1 to 13 and Comparative Examples 1 to 5.

(Curelasto Test)

Time T10 (minutes) at which torque was raised by 10% by vulcanizing test pieces while applying vibration at 160° C. using a curelastometer was measured. Here, it is indicated that when T10 is at least 1.7 minutes, rubber scorch during rubber vulcanization can be suppressed.

(Air Permeation Test)

The air permeation quantity of the vulcanized rubber sheets was measured in accordance with the ASTM D-1434-75M method. The air permeation index of Comparative Example 1 was referred to as 100 and the air permeation quantities of respective compoundings were displayed by indices according to the following calculation formula. Here, it is indicated that the larger the air permeation resistance index is, the less the air permeation quantity of the vulcanized rubber sheet is. And the air permeation resistance of the vulcanized rubber sheet is improved, and it is preferable. The air permeation resistance index is preferably at least 90.

(Air permeation resistance index)=(Air permeation quantity of each compounding)÷(Air permeation quantity of Comparative Example 1)×100

(Viscoelasticity Test)

The loss tangent tan δ of the vulcanized rubber sheets at 70° C. was measured under the conditions of a frequency of 10 Hz, an initial strain of 10% and a dynamic strain of 2% using a viscoelastic spectrometer manufactured by Iwamoto Seisakusyo K.K. Here, it is indicated that the smaller the tan δ is, the smaller the heat build-up is and the more superior the low heat build-up property is. Tan δ is preferably at most 0.150, but when the air permeation index exceeds 120, rubber gauge itself can be made thin; therefore tan δ is preferably at most 0.170.

(Tensile Test)

Elongation at break (EB %) was measured according to JIS K 6251 “Vulcanized rubber and thermoplastic rubber—Determination method of tensile property”, using No.3 dumbbell type test pieces comprising the fore-mentioned vulcanized rubber sheets of Examples 1 to 13 and Comparative Examples 1 to 5. Here, it is indicated that the larger the EB is, the more superior the rubber strength is. EB is preferably at least 500.

TABLE 1

| Examples | | | | | | |
|---|---|---|---|---|---|---|
| 1 | 2 | 3 | 4 | 5 | 6 | 7 |

Compounding amount
(parts by weight)

| | | | | | | | |
|---|---|---|---|---|---|---|---|
| Chloro butyl | 80 | 80 | 80 | 80 | 80 | 100 | 80 |
| NR | 20 | 20 | 20 | 20 | 20 | — | — |
| BR | — | — | — | — | — | — | 20 |
| ENR | — | — | — | — | — | — | — |
| Carbon N660 | 45 | 45 | 35 | 25 | 35 | 35 | 45 |
| Silica Z115Gr | — | — | 10 | 20 | 10 | 10 | — |
| Stearic acid | 1 | 1 | 1 | 1 | 1 | 1 | 1 |
| Mineral oil | 8 | 8 | 8 | 8 | 8 | 8 | 8 |
| Silane coupling agent | — | — | — | 1.8 | — | — | — |
| (Pure sulfur content) | | | | (0.414) | | | |
| Zinc oxide | 3 | 3 | 3 | 3 | 3 | 3 | 3 |
| Sulfur treated with 5% oil | 0.4 | 0.3 | 0.3 | 0.3 | 0.2 | 0.3 | 0.3 |
| (Pure sulfur content) | (0.38) | (0.285) | (0.285) | (0.285) | (0.19) | (0.285) | (0.285) |
| HTS | — | — | — | — | — | — | — |
| (Pure sulfur content) | | | | | | | |
| Vulcanization accelerator DM | 1.0 | 1.0 | 1.0 | 1.0 | 1.0 | 1.0 | 1.0 |
| TACKROL V200 | 1 | 2 | 2 | 2 | 4 | 2 | 2 |
| (Pure sulfur content) | (0.24) | (0.48) | (0.48) | (0.48) | (0.96) | (0.48) | (0.48) |
| Whole sulfur content | 0.62 | 0.765 | 0.765 | 1.179 | 1.15 | 0.765 | 0.765 |

Evaluation result

| | | | | | | | |
|---|---|---|---|---|---|---|---|
| T10 (160° C.) | 2.7 | 2.0 | 2.4 | 2.8 | 2.2 | 2.7 | 2.4 |
| tanδ (70° C.) | 0.140 | 0.135 | 0.138 | 0.143 | 0.125 | 0.155 | 0.130 |
| Air permeation index | 102 | 101 | 100 | 100 | 103 | 125 | 94 |
| EB (%) | 610 | 630 | 660 | 680 | 620 | 610 | 580 |

TABLE 2

| Examples | | | | | |
|---|---|---|---|---|---|
| 8 | 9 | 10 | 11 | 12 | 13 |

Compounding amount
(parts by weight)

| | | | | | | |
|---|---|---|---|---|---|---|
| Chloro butyl | 80 | 80 | 80 | 65 | 80 | 80 |
| NR | 20 | 20 | — | 35 | 20 | 20 |
| BR | — | — | — | — | — | — |
| ENR | — | — | 20 | — | — | — |
| Carbon N660 | 20 | 15 | 45 | 45 | 45 | 45 |
| Silica Z115Gr | 10 | 30 | — | — | — | — |
| Stearic acid | 1 | 1 | 1 | 1 | 1 | 1 |
| Mineral oil | 8 | 8 | 8 | 8 | 8 | 8 |
| Silane coupling agent | — | 2.4 | — | — | — | — |
| (Pure sulfur content) | | (0.552) | | | | |
| Zinc oxide | 3 | 3 | 3 | 3 | 3 | 3 |
| Sulfur treated with 5% oil | 0.3 | 0.3 | 0.3 | 0.4 | 0.5 | 0.4 |
| (Pure sulfur content) | (0.285) | (0.285) | (0.285) | (0.38) | (0.475) | (0.38) |
| HTS | — | — | — | — | — | 0.4 |
| (Pure sulfur content) | | | | | | (0.38) |
| Vulcanization accelerator DM | 1.0 | 1.0 | 1.0 | 1.0 | 1.0 | 1.0 |
| TACKROL V200 | 2 | 2 | 2 | 1 | 0.5 | 1 |
| (Pure sulfur content) | (0.48) | (0.48) | (0.48) | (0.24) | (0.12) | (0.24) |
| Whole sulfur content | 0.765 | 1.317 | 0.765 | 0.62 | 0.595 | 1.18 |

Evaluation result

| | | | | | | |
|---|---|---|---|---|---|---|
| T10 (160° C.) | 2.8 | 2.7 | 2.5 | 2.3 | 3.1 | 2.4 |
| tanδ (70° C.) | 0.127 | 0.150 | 0.139 | 0.120 | 0.157 | 0.135 |
| Air permeation index | 101 | 99 | 110 | 92 | 102 | 101 |
| EB (%) | 640 | 690 | 640 | 590 | 600 | 570 |

TABLE 3

| Comparative Examples | | | | |
|---|---|---|---|---|
| 1 | 2 | 3 | 4 | 5 |

Compounding amount
(parts by weight)

| | | | | | |
|---|---|---|---|---|---|
| Chloro butyl | 80 | 45 | 80 | 80 | 80 |
| NR | 20 | 55 | 20 | 20 | 20 |
| BR | — | — | — | — | — |
| ENR | — | — | — | — | — |
| Carbon N660 | 60 | 35 | 45 | — | 45 |
| Silica Z115Gr | — | 10 | 10 | 55 | — |
| Stearic acid | 1 | 1 | 1 | 1 | 1 |
| Mineral oil | 12 | 8 | 8 | 8 | 8 |
| Silane coupling agent | — | — | — | 4.4 | — |
| (Pure sulfur content) | | | | (1.012) | |
| Zinc oxide | 3 | 3 | 3 | 3 | 3 |
| Sulfur treated with 5% oil | 0.5 | 0.3 | 0.3 | 0.3 | — |
| (Pure sulfur content) | (0.475) | (0.285) | (0.285) | (0.285) | |
| HTS | — | — | — | — | — |
| (Pure sulfur content) | | | | | |
| Vulcanization accelerator DM | 1.2 | 1.0 | 1.0 | 1.0 | 1.0 |
| TACKROL V200 | — | 2 | 2 | 2 | 7 |
| (Pure sulfur content) | | (0.48) | (0.48) | (0.48) | (1.68) |
| Whole sulfur content | 0.475 | 0.765 | 0.765 | 1.777 | 1.68 |

Evaluation result

| | | | | | |
|---|---|---|---|---|---|
| T10 (160° C.) | 3.6 | 1.7 | 1.9 | 3.6 | 1.6 |
| tanδ (70° C.) | 0.210 | 0.095 | 0.151 | 0.159 | 0.125 |
| Air permeation index | 100 | 65 | 100 | 97 | 98 |
| EB (%) | 510 | 570 | 670 | 710 | 430 |

### INDUSTRIAL APPLICABILITY

According to the present invention, a rubber composition for an inner liner capable of keeping air permeation resistance and being superior in low heat build-up property and durability can be provided by compounding a specific amount of carbon black and/or silica and a specific amount of an alkylphenol-sulfur chloride condensate against a rubber component including a butyl rubber and by setting a whole sulfur content at a specific amount.

1-3. (canceled)

4. A rubber composition for an inner liner comprising
21 to 50 parts by weight of (B) carbon black and/or silica and
0.25 to 6 parts by weight of (C) an alkylphenol-sulfur chloride condensate indicated by the formula (C1): 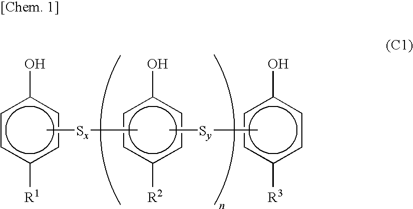
(Wherein R¹ to R³ are same or different and either is an alkyl group having 5 to 12 carbons; x and y are same or different and either is an integer of 2 to 4; n is an integer of 0 to 10.), and comprising 0.1 to 0.49 parts by weight of sulfur, wherein whole sulfur content is 0.3 to 1.5 parts by weight,
based on 100 parts by weight of (A) a rubber component comprising 60 to 100% by weight of a butyl rubber.

5. The rubber composition for an inner liner of claim 4, wherein the rubber component (A) comprises 60 to 80% by weight of a butyl rubber.

6. The rubber composition for an inner liner of claim 4, wherein the rubber component (A) is a rubber component comprising 60 to 90% by weight of a butyl rubber and 10 to 40% by weight of an epoxidized natural rubber.

7. The rubber composition for an inner liner of claim 4, wherein the rubber component (A) is a rubber component consisting of a butyl rubber, and a natural rubber, an epoxidized natural rubber or a butadiene rubber, and the content of the butyl rubber is 60 to 90% by weight, and
wherein the (B) is carbon black and silica.

8. A tire having an inner liner comprising the rubber composition for an inner liner of claim 4.
